(19) United States
(12) Patent Application Publication
(10) Pub. No.: US 2014/0172473 A1
(43) Pub. Date: Jun. 19, 2014

(54) VEHICLE MANAGING SYSTEM AND METHOD

(71) Applicants: HON HAI PRECISION INDUSTRY CO., LTD., New Taipei (TW); HONG FU JIN PRECISION INDUSTRY (ShenZhen) CO.,LTD., Shenzhen (CN)

(72) Inventors: KUNG-CHIEH CHENG, New Taipei (TW); FU-QIANG HE, Shenzhen (CN)

(73) Assignees: HON HAI PRECISION INDUSTRY CO., LTD., New Taipei (TW); HONG FU JIN PRECISION INDUSTRY (Shenzhen) CO.,LTD., Shenzhen (CN)

(21) Appl. No.: 14/101,409

(22) Filed: Dec. 10, 2013

(30) Foreign Application Priority Data
Dec. 14, 2012 (CN) 201210542019X

(51) Int. Cl. G06Q 10/02; G06Q 50/30

(52) U.S. Cl. CPC G06Q 10/02; G06Q 50/30
USPC 705/5

(57) ABSTRACT

A vehicle managing system controlling a number of access controls of a parking lot comprises a storage unit and an assigning unit. The storage unit stores a reservation list and a parking space list. The reservation list registers identifiable information and a reserved parking area comprising at least one parking space. The parking space list registers an occupied state or an empty state of each parking space. The identifiable information is stored in a unique identifier and can be obtained by the access control when the vehicle enters or leaves the parking lot. The assigning unit determines whether there are any available parking spaces in the reserved parking area, and assigns a parking space to the vehicle if there is an empty parking space. A vehicle managing method applied to the vehicle managing system is also provided.

### BACKGROUND

1. Technical Field

The present disclosure relates to managing systems and methods, and particularly to a system and method for managing vehicles in a parking lot.

2. Description of Related Art

Parking lots can be managed automatically by computers to open gates to allow cars to enter and exit the parking lot. However, drivers have no way of knowing whether there are any empty parking spaces available. If there are no empty parking spaces available, the parking lot may become congested if too many cars enter the parking lot.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 illustrates an embodiment of a parking lot utilizing a vehicle managing system.

FIG. 2 is block diagram of function modules of the vehicle managing system.

FIGS. 3-4 are a flowchart of a vehicle managing method implemented by the vehicle managing system.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

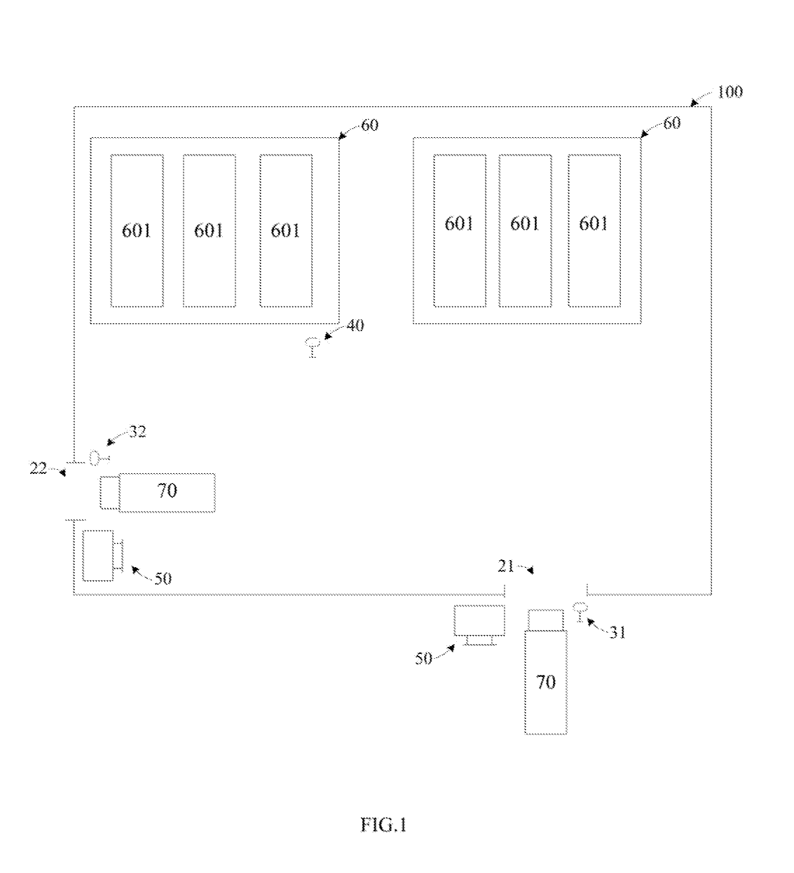

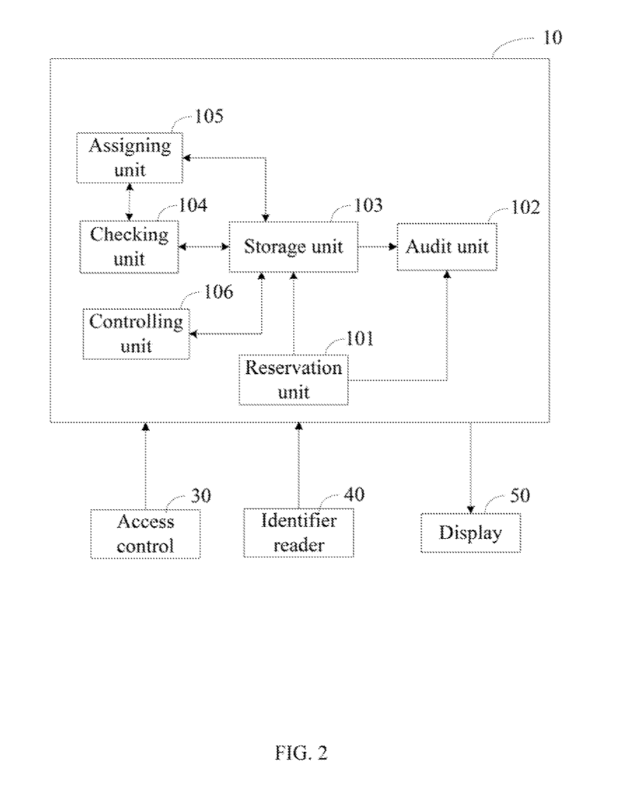

Referring to FIG. 1 and FIG. 2, a parking lot 100 applies a vehicle managing system 10. The vehicle managing system 10 is contained in a device (not shown in figures). The device comprises at least one hardware processor. In one embodiment, the parking lot 100 is a parking lot of a factory. The parking lot 100 comprises at least one entry point 21, at least one exit point 22, a number of access controls 30 (only one shown in FIG. 2), a number of identifier readers 40 (only one shown in figures), a number of displays 50, and a number of parking areas 60. The access control 30 includes at least one entrance access control 31 and at least one exit access control 32. Each parking area 60 further comprises a number of parking spaces 601. Each parking area 60 can be reserved by a driver of a vehicle 70.

The vehicle managing system 10 assigns a unique identifier to each vehicle 70 for identification purposes. The unique identifier can be, but is not limited to, an Integrated Circuit (IC) card, a Radio Frequency Identification (RFID) card, or a RFID User Identity Model (RFID-UIM) card contained in a phone. Each unique identifier registers identifiable information of a corresponding vehicle 70. The identifiable information can be, but is not limited to be, vehicle registration numbers, identifier numbers, and phone numbers of the drivers of the corresponding vehicles 70.

The entrance access control 31 and the exit access control 32 communicate with the vehicle managing system 10 wirelessly or in wired. When the vehicle 70 enters the parking lot 100, the entrance access control 31 obtains identifiable information from the unique identifier and controls the entry point 21 to open to allow the vehicle 70 to enter the parking lot 100. When the vehicle 70 exits the factory area, the exit access control 32 obtains identifiable information from the unique identifier and controls the exit point 22 to open to allow the vehicle 70 to exit the parking lot 100.

The identifier readers 40 communicate with the vehicle managing system 10 wirelessly or in wired. Each identifier reader 40 corresponds to one parking space 601 and monitors a state of the corresponding parking space 601. When the vehicle 70 parks in a parking space 601, the identifier reader 40 obtains identifiable information of the vehicle 70 from the unique identifier.

The displays 50 communicate with the vehicle managing system 10 wirelessly or in wired for displaying prompt information.

In one embodiment, the vehicles 70 can be a special type or a common type. The special type is a vehicle for transporting goods and need to be checked by an inspection staff after entering the parking lot 100 or before leaving the parking lot 100. The common type does not need to be checked by the inspection staff.

The vehicle managing system 10 comprises one or more programs, the one or more programs comprises a storage unit 103, a reservation unit 101, an audit unit 102, a checking unit 104, an assigning unit 105, and a controlling unit 106.

The reservation unit 101 receives reservation information inputted by the driver of the corresponding vehicle 70. The reservation information comprises a desired parking area 60 and the type of the vehicle 70. In this embodiment, the driver inputs the reservation information on a website provided by the vehicle managing system 10.

The audit unit 102 determines whether the reservation information is qualified and adds the reservation information to a reservation list if the reservation information is qualified. The reservation list registers the identifiable information of each vehicle 70 and the corresponding reservation information. In this embodiment, the audit unit 102 determines whether the reservation information is qualified in response to an administrator's operation. In other embodiments, the reservation unit 101 adds the reservation information to the reservation list directly.

The storage unit 103 stores the reservation list and a parking space list. The parking space list records a state of each parking space 601, wherein the state of the parking space can be an occupied state or an empty state. In other embodiments, the storage unit 103 stores the reservation list according to a preset operation. Thus, the driver does not need to make a reservation.

For the vehicle 70 to enter the parking lot 100, the entrance access control 31 obtains the identifiable information from the unique identifier of the vehicle 70. The checking unit 104 determines whether the vehicle 70 has permission to enter the parking lot 100 by searching the reservation list. If the vehicle 70 does not have permission to enter, the entry point 21 is not opened, the vehicle 70 can not enter the parking lot 100.

If the vehicle 70 has the permission to enter the parking lot 100, the checking unit 104 determines whether the number of the vehicle in the parking lot 100 is greater than a predetermined value. In detail, the number of the vehicle 70 plus one. When the vehicle 70 exits the parking lot 100, the number of the vehicle 70 minus one. If the number of the vehicle in the parking lot 100 is greater than the predetermined value, the entry point 21 is not opened, the vehicle 70 can not enter the parking lot 100.

If the number of the vehicle in the parking lot 100 is less than or equal to the predetermined, the checking unit 104 further determines whether the vehicle 70 is the special type according to the reservation list. If the vehicle 70 is the special type, the checking unit 104 determines whether the vehicle 70 needs to be checked by inspection staff. If the vehicle 70 needs to be checked by inspection staff, the checking unit 104 generates a warning message to inform the inspection staff to check the vehicle 70. If the vehicle 70 does not need to be checked by inspection staff, the checking unit 104 generates an assign instruction.

The assigning unit 105 assigns a parking space 601 in the corresponding reserved parking area 60 to the vehicle 70 in response to the assign instruction. In detail, the assigning unit 105 searches the parking space list for determining whether any empty parking spaces 601 of the reserved parking area 60 are available. If there is at least one empty parking space 601 of the reserved parking area 60 available, the assigning unit 105 assigns an empty parking space 601 of the reserved parking area 60 to the vehicle 70 randomly. If there are no more empty parking spaces 601 available in the reserved parking area 60, the assigning unit 105 generates a prompt instruction for controlling the display 50 to display a warning message to inform the driver that there are no more empty parking spaces 601 available in the reserved parking area 60.

When the vehicle 70 parks in the assigned parking area 60, the identifier reader 40 obtains the identifiable information according to the unique identifier of the vehicle 70 for generating a determining instruction. The controlling unit 106 determines whether the parking space 601 that the vehicle 70 parks in is the assigned parking space 601 in response to the determining instruction. If the parking space 601 is the assigned parking space 601, the controlling unit 106 changes the state of the assigned parking space 601 to the occupied state. If the parking space 601 is not the assigned parking space 601, the controlling unit 106 generates a message to inform the driver that the current parking space 601 is not the assigned parking space 601 and informs the driver as to the correct assigned parking space 601.

When the vehicle 70 exits the assigned parking space 601, the identifier reader 40 obtains the identifiable information from the unique identifier of the vehicle 70 for generating a changing instruction. The controlling unit 106 changes the state of the assigned parking space 601 to the empty state in response to the changing instruction.

Before the vehicle 70 exits the factory area, the exit access control 32 obtains the identifiable information of the vehicle 70 for generating a leaving instruction. The checking unit 104 determines whether the vehicle type is the special type by searching the reservation list according to the identifiable information. If the type of the vehicle 70 is the special type, the checking unit 104 determines whether the vehicle 70 needs to be checked by the inspection staff. If the vehicle 70 needs to be checked by the inspection staff, the checking unit 104 generates a warning message for informing the inspection staff to check the vehicle 70. If the vehicle 70 does not need to be checked by the inspection staff, the checking unit 104 generates a check instruction. If the vehicle is not the special type, the checking unit 104 generates the check instruction.

The checking unit 104 determines whether the vehicle 70 has permission to leave the parking lot 100 in response to the check instruction. If the vehicle 70 has permission to leave, the checking unit 104 generates a second controlling signal for controlling the exit access control 32 to open the exit point 22 to allow the vehicle 70 to exit. If the vehicle does not have permission to leave the parking lot 100, the exit point 22 is not opened, and the display 50 displays a message for informing the driver that the vehicle 70 cannot pass the exit point 22.

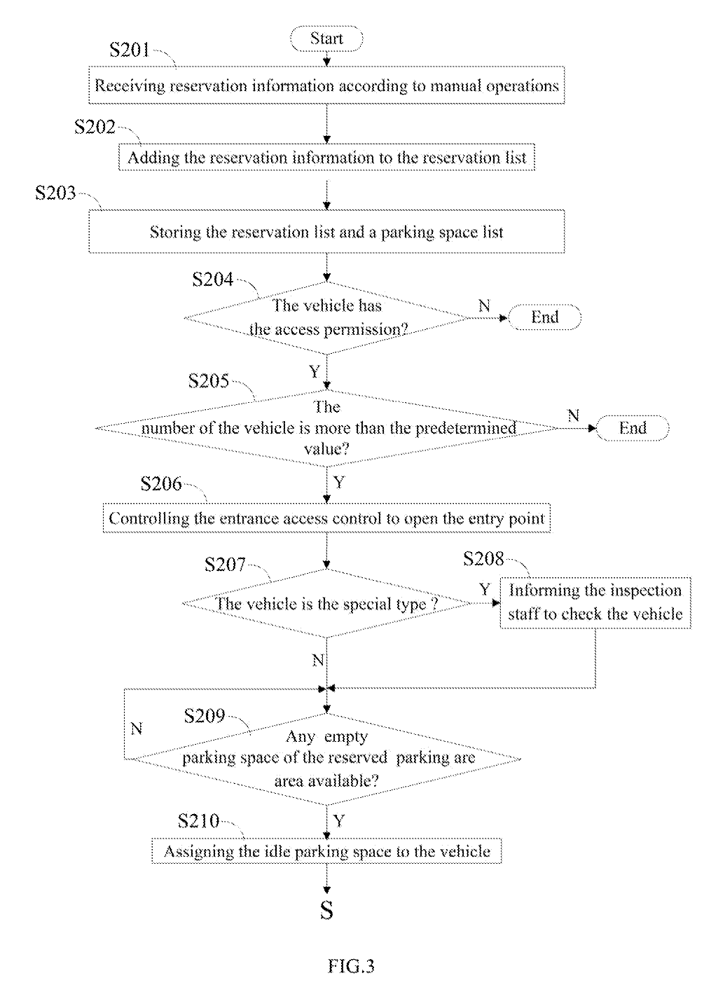

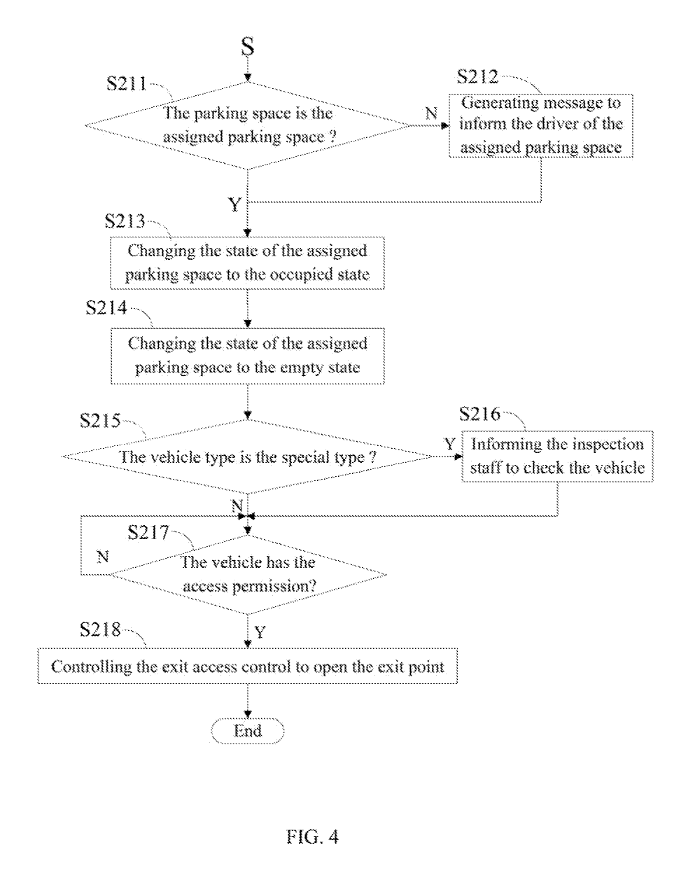

FIGS. 3 and 4 show a flowchart of a vehicle managing method. The method is applied in the vehicle managing system 10 contained in a device capable of communicating with a plurality of access controls of a parking lot, the vehicle managing system capable of executed by a processor to perform instructions stored in a storage module of the device, the device comprising one or more programs. The method comprises the following steps:

In step S201, the reservation unit 101 receives reservation information inputted by the driver of the corresponding vehicle 70. The reservation information comprises the desired parking area 60 and the type of the vehicle 70. In this embodiment, the driver inputs the reservation information on a website provided by the vehicle managing system 10.

In step S202, the audit unit 102 determines whether the reservation information is qualified and adds the reservation information to a reservation list if the reservation information is qualified. The reservation list registers the identifiable information of each vehicle 70 and the corresponding reservation information. In this embodiment, the audit unit 102 determines whether the reservation information is qualified in response to an administrator's operation. In other embodiments, the reservation unit 101 adds the reservation information to the reservation list directly.

In step S203, the storage unit 103 stores the reservation list and a parking space list. The parking space list records a state of each parking space 601, wherein the state of the parking space can be an occupied state or an empty state. In other embodiments, the storage unit 103 stores the reservation list according to a preset operation. Thus, the driver does not need to make a reservation.

In step S204, for the vehicle 70 to enter the parking lot 100, the entrance access control 31 obtains the identifiable information from the identifier of the vehicle 70. The checking unit 104 determines whether the vehicle 70 has permission to enter the parking lot 100 by searching the reservation list. If the vehicle 70 has permission to enter the parking lot 100, step S205 is implemented. If the vehicle 70 does not have permission to enter the parking lot 100, the entry point 21 is not opened, the vehicle 70 can not enter the parking lot 100.

In step S205, the checking unit 104 determines whether the number of the vehicle in the parking lot 100 is greater than a predetermined value. In detail, the number of the vehicle is counted by the checking unit 104. When the vehicle 70 enters the parking lot 100, the number of the vehicle 70 plus one. When the vehicle 70 exits the parking lot 100, the number of the vehicle 70 minus one. If the number of the vehicle in the parking lot 100 is more than the predetermined value, the entry point 21 is not opened. If the number of the vehicle in the parking lot 100 is less than or equal to the predetermined value, step S206 is implemented.

In step S206, the checking unit 104 controls the entrance access control 31 to open the entry point 21 to allow the vehicle 70 to enter.

In step S207, the checking unit 104 determines whether the vehicle 70 is the special type according to the reservation list. If the vehicle 70 is the special type, step S208 is implemented. If the vehicle 70 is not the special type, step S209 is implemented.

In step S208, the checking unit 104 informs the inspection staff to check the vehicle 70.

In step S209, the assigning unit 105 searches the parking space list for determining whether any empty parking spaces 601 of the reserved parking area 60 are available. If there are empty parking spaces 601 of the reservation area 60 available, step S210 is implemented. If there are no empty parking spaces 601 of the reservation area 60 available, the display 50 displays a warning message for informing that there are no empty parking spaces 601 in the reservation parking area, and the driver parks the vehicle 70 in the driveway to wait the other vehicle 70 leaves the parking spaces 601.

In step S210, the assigning unit 105 assigns an empty parking space to the vehicle 70 randomly.

In step S211, when the vehicle 70 enters the parking space 601, the identifier reader 40 obtains the identifiable information according to the unique identifier of the vehicle 70. The controlling unit 106 determines whether the current parking space 601 is the assigned parking space corresponding to the vehicle 70. If the current parking space 601 is not the assigned parking space 601, step S212 is implemented. If the current parking space 601 is the assigned parking space 601, step S213 is implemented.

In step S212, the controlling unit 106 generates a message to inform the driver that the current parking space 601 is not the assigned parking space 601 and informs the driver of the assigned parking space as to the correct parking space 601.

In step S213, the controlling unit 106 changes the state of the assigned parking space 601 to the occupied state.

In step S214, when the vehicle 70 exits the assigned parking space 601, the controlling unit 106 changes the state of the assigned parking space 601 to the empty state.

In step S215, before the vehicle 70 exits the parking lot 100, the access control 32 obtains the identifiable information of the vehicle 70. The checking unit 104 determines whether the vehicle type is the special type by searching the reservation list according to the identifiable information. If the vehicle type is the special type, step S216 is implemented. If the vehicle type is not the special type, step S217 is implemented.

In step S216, the checking unit 104 generating a warning message for informing the inspection staff to check the vehicle 70.

In step S217, the checking unit 104 determines whether the vehicle 70 has permission to exit the parking lot 100. If the vehicle 70 has permission to exit the parking lot 100, step S218 is implemented. If the vehicle 70 does not have permission to exit the parking lot 100, the exit point 22 is not opened, and the display 50 displays a message for informing the driver that the vehicle 70 can not pass the exit point 22.

In step S218, the checking unit 104 controls the exit access control 32 to open the exit point 22 to allow the vehicle 70 to exit.

Although information and the advantages of the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A vehicle managing system of a device capable of communicating with a plurality of access controls of a parking lot, the device comprises at least one hardware processor, the vehicle managing system comprises one or more programs, the one or more programs comprises:
a storage unit for storing a reservation list and a parking space list, wherein the reservation list registers identifiable information and a reserved parking area which comprises at least one parking space corresponding to at least one vehicle, the parking space list records the state of the parking space which comprises an occupied state and an empty state, wherein the identifiable information is stored in a unique identifier and can be obtained by the access controls when the vehicle entering the factory area; and
an assigning unit for determining whether any empty parking space of the reserved parking area corresponding to the identifiable information are available according to the parking space list, and assigning an empty parking space to the vehicle when there is at least one empty parking space of the reserved parking area available.

2. The vehicle managing system of claim 1, the vehicle managing system further comprises a checking unit for determining whether the vehicle has access permission, wherein if the vehicle has access permission, the checking unit controls the access controls to allow the vehicle to enter the factory area.

3. The vehicle managing system of claim 1, wherein the identifiable information can be a vehicle registration number, an identifier number, or the phone number of a driver of the vehicle.

4. The vehicle managing system of claim 1, further comprising:
a reservation unit for receiving the reserved parking area corresponding to the vehicle according to manual operations; and
an audit unit for determining whether the reservation information is qualified, and adding the reserved to the reservation list if the reservation parking area is qualified.

5. The vehicle managing system of claim 1, further comprising:
a controlling unit for changing the state of the parking space to the occupied state when the vehicle parking in the parking space, and changing the state of the parking space to the empty state when the vehicle leaves the parking space.

6. The vehicle managing system of claim 3, wherein the controlling unit is used for determining whether the parking space is the assigned parking space when the vehicle is parked in the parking space, and generating a message for informing the driver that the parking space is wrong if the parking space is not the assigned parking space.

7. A vehicle managing method for the vehicle managing system of a device capable of communicating with a plurality of access controls of a parking lot, the vehicle managing system is capable of executed by a processor to perform instructions stored in a storage module of the device, the device comprising one or more programs; the vehicle managing method comprising:
providing a reservation list and a parking space list, the reservation list registers identifiable information and a reserved parking area which comprises at least one parking space corresponding to at least one vehicle, the parking space list records the state of the parking space which comprises an occupied state and an empty state, wherein the identifiable information is stored in a unique identifier and can be obtained by the access control when the vehicle enters the factory area;
determining whether any empty parking space of the reserved parking area corresponding to the identifiable information are available according to the parking space list; and
assigning an empty parking space to the vehicle when there is at least one empty parking space of the reserved parking area available.

8. The vehicle managing method of claim 7, wherein the reservation list further registers an access privilege of the vehicle, the vehicle managing method further comprising:
determining whether the vehicle has access permission, wherein if the vehicle has access permission, for controlling the vehicle to allow the vehicle to enter the factory area.

9. The vehicle managing method of claim 7, wherein the identifiable information can be a vehicle registration number, an identifier number, or the phone number of a driver of the vehicle.

10. The vehicle managing method of claim 7, further comprising:
receiving the reserved parking area corresponding to the vehicle according to manual operations; and
determining whether the reserved parking area is qualified, and adding the reservation information to the reservation list if the reserved parking area is qualified.

11. The vehicle managing method of claim 7, further comprising:
changing the state of the parking space to the occupied state when the vehicle parking in the parking space, and changing the state of the parking space to the empty state when the vehicle leaves the parking space.

12. The vehicle managing method of claim 11, further comprising:
determining whether the parking space is the assigned parking space when the vehicle is parked in the parking space; and
generating a message for informing the driver that the parking space is wrong if the parking space is not the assigned parking space.
